(19) United States
(12) Patent Application Publication
(10) Pub. No.: US 2025/0299347 A1
(43) Pub. Date: Sep. 25, 2025

(54) OPERATION PROCESSING DEVICE AND OPERATION PROCESSING METHOD

(71) Applicant: NEC Corporation, Tokyo (JP)

(72) Inventor: Hideki KIMURA, Tokyo (JP)

(73) Assignee: NEC Corporation, Tokyo (JP)

(21) Appl. No.: 19/068,054

(22) Filed: Mar. 3, 2025

(30) Foreign Application Priority Data
Mar. 25, 2024 (JP) 2024-047754

(51) Int. Cl. G06T 7/33; G06T 7/73

(52) U.S. Cl. CPC G06T 7/33; G06T 7/73; G06T 2207/10032; G06T 2207/30232

(57) ABSTRACT

In the operation processing unit, the position calculation unit calculates positions of objects corresponding to the bright spots based on positions of the extracted bright spots in the image, and calculating shooting times of image captured by the sensors. The object identification unit obtains position information of known objects from object catalog information, and associates the objects whose positions are calculated with a known object, based on the position information of the known object and the calculated positions. The position registration unit registers the calculated position and shooting time of image in the object catalog information, based on a result of association. The object identification unit extracts the bright spot to be monitored from the bright spots other than the predetermined objects, based on the result of association. The calculation unit identifies the position and shooting time of an object to be monitored.

### CROSS-REFERENCE TO RELATED APPLICATION

This application is based upon and claims the benefit of priority from the prior Japanese Patent Application No. 2024-047754, filed on Mar. 25, 2024, the entire disclosure of which is hereby incorporated.

### BACKGROUND OF THE INVENTION

### Technical Field

This disclosure relates to an operation processing device, an operation processing method, and operation processing program.

### Description of the Related Art

In recent years, private companies providing internet access and other services have launched hundreds to thousands of satellites and started operating satellites and providing services. It is also known that some satellites have been making suspicious movements, such as approaching communications satellites of other countries and intercepting their communications. It is very important to know the position of such satellites and other objects moving in space in order to avoid accidents such as satellite collisions. In addition, understanding the existence and movement of suspicious satellites provides useful information for the security of a country and its allies.

In general, ground-based optical telescopes and radar devices are used to determine the position of objects such as satellites in space. In general, optical telescopes are used to observe objects at a distance from the ground (for example, objects in geostationary orbit), and radar devices are used to observe objects at relatively short distances from the ground (for example, objects in low orbit).

In addition, patent literature 1 describes a device for obtaining space object information that represents the status of space objects flying in space and for managing space object information.

### CITATION LIST

### Patent Literature

[Patent Literature 1] Japanese Patent Application Publication No. 2024-15352

### SUMMARY OF THE INVENTION

When observing an object in space with an optical telescope, it is not possible to observe it during the daytime or when clouds are present. In other words, optical telescopes can only observe objects at night when there are no clouds. Therefore, regular observations cannot be made with an optical telescope. If a satellite changes its orbit at a time when observation is not possible, the exact position of the satellite cannot be determined, which may lead to accidents such as collisions or security concerns.

Observations by radar device are not affected by the presence or absence of clouds or by day or night. However, since radar device transmits radio waves from the ground, it is subject to regulations under the Radio Law. Therefore, it is difficult to use radar device freely. In addition, in order to observe objects in geostationary orbit with a radar device, it is necessary to transmit radio waves with a large output power, and the facility for radar device becomes large. Furthermore, in order to ensure that the surroundings of the radar device are not affected by radio waves, consideration must be given to the location of the antenna of the radar device.

It is preferable to be able to observe the position of objects in space constantly or periodically without various restrictions or regulations.

It is also possible to observe the position of an object in space with observation device in space (for example, a satellite dedicated for observation or a star tracker equipped with a satellite). However, if a satellite dedicated for observation is used, the development and launch of the satellite usually requires a cost of more than 10 billion yen. In addition, the star trackers have a narrow viewing angle of about 20 degrees, which limits the area that can be observed when using the star tracker. Therefore, it is undesirable to use a satellite dedicated for observation or a star tracker to observe objects.

As mentioned above, it is desirable to be able to observe the position of objects in space constantly or periodically without various restrictions or regulations.

Therefore, the purpose of present disclosure is to provide an operation processing device, an operation processing method, and an operation processing program that can constantly or periodically observe the position of objects in space without various restrictions or regulations.

The operation processing device according to the present disclosure includes data processing means for converting image data obtained by sensors installed on an observation satellite into a format that can be recognized as an image, bright spot extraction means for extracting bright spots other than predetermined objects from bright spots in the image represented by the image data, position calculation means for calculating positions of objects corresponding to the bright spots based on positions of the extracted bright spots in the image, and calculating shooting times of image captured by the sensors, object identification means for obtaining position information of known objects from object catalog information, and associating the objects whose positions are calculated with a known object, based on the position information of the known object and the calculated positions, position registration means for registering the calculated position and shooting time of image in the object catalog information, based on a result of association, and calculation means for identifying the position and shooting time of an object to be monitored, wherein the object identification means extracts the bright spot to be monitored from the bright spots other than the predetermined objects, based on the result of association, and the calculation means calculates a movement direction and movement speed of the object to be monitored.

The operation processing method according to the present disclosure includes converting image data obtained by sensors installed on an observation satellite into a format that can be recognized as an image, extracting bright spots other than predetermined objects from bright spots in the image represented by the image data, calculating positions of objects corresponding to the bright spots based on positions of the extracted bright spots in the image, and calculating shooting times of image captured by the sensors, obtaining position information of known objects from object catalog information, and associating the objects whose positions are calculated with a known object, based on the position information of the known object and the calculated positions, registering the calculated position and shooting time of image in the object catalog information, based on a result of association, extracting the bright spot to be monitored from the bright spots other than the predetermined objects, based on the result of association, identifying the position and shooting time of an object to be monitored, and calculating a movement direction and movement speed of the object to be monitored.

The operation processing program according to the present disclosure causes a computer to execute a process of converting image data obtained by sensors installed on an observation satellite into a format that can be recognized as an image, a process of extracting bright spots other than predetermined objects from bright spots in the image represented by the image data, a process of calculating positions of objects corresponding to the bright spots based on positions of the extracted bright spots in the image, and calculating shooting times of image captured by the sensors, a process of obtaining position information of known objects from object catalog information, and associating the objects whose positions are calculated with a known object, based on the position information of the known object and the calculated positions, a process of registering the calculated position and shooting time of image in the object catalog information, based on a result of association, a process of extracting the bright spot to be monitored from the bright spots other than the predetermined objects, based on the result of association, a process of identifying the position and shooting time of an object to be monitored, and a process of calculating a movement direction and movement speed of the object to be monitored.

According to the present disclosure, the position of an object in space can be observed constantly or periodically without various restrictions or regulations.

### BRIEF DESCRIPTION OF THE DRAWINGS

FIG. 1: It depicts a schematic diagram showing a constellation satellite equipped with sensors.

FIG. 2: It depicts a schematic diagram showing a field of view of each sensor in the case of one constellation satellite with five sensors.

FIG. 3: It depicts a schematic diagram showing a field of view of each sensor in the case of one constellation satellite with five sensors.

FIG. 4: It depicts a schematic diagram showing a field of view of each sensor and a position relation to the earth and other satellites.

FIG. 5: It depicts a schematic diagram showing an example of the zenith field of view for multiple constellation satellites.

FIG. 6: It depicts a schematic diagram showing an example of an image based on image data obtained by a single sensor.

FIG. 7: It depicts a block diagram showing an example of the configuration of the operation processing device for the present disclosure.

FIG. 8: It depicts a flowchart showing an example of the processing flow of the operation processing device.

FIG. 9: It depicts a flowchart showing an example of the processing flow of the operation processing device.

FIG. 10: It depicts a block diagram showing an example of the configuration of a computer for the operation processing device.

FIG. 11: It depicts a block diagram showing an overview of the operation processing device for the present disclosure.

### DESCRIPTION OF THE PREFERRED EMBODIMENTS

Hereinafter, an example embodiment of the present disclosure will be explained with reference to the drawings.

The operation processing device for the present disclosure uses satellites belonging to a satellite constellation that are equipped with sensors. Hereafter, satellites belonging to a satellite constellation are referred to as constellation satellites. There may be more than one constellation satellite equipped with a sensor. Sensors carried on constellation satellites include, but are not limited to, optical cameras, fulldome cameras, radars, etc.

The operation processing unit of the present disclosure receives observation data obtained by the sensor from the sensor of the constellation satellite and calculates the position of an object in space. The following is an example of a case in which the observation data obtained by the sensor is image data.

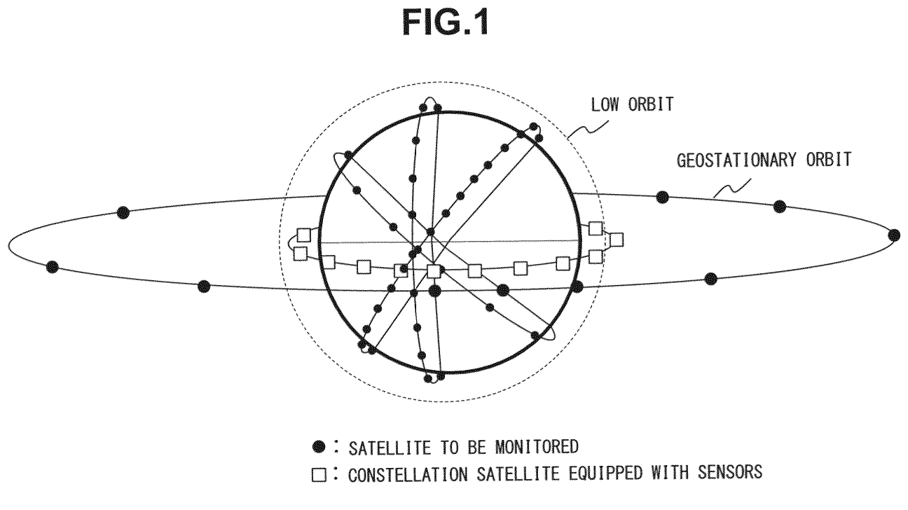

FIG. 1 is a schematic diagram of a constellation satellite equipped with a sensor. In FIG. 1, the rectangle represents the constellation satellite equipped with the sensor. The circles indicate satellites to be monitored. As shown in FIG. 1, there can be multiple constellation satellites equipped with sensors.

This form of satellite navigation will be described using the example of a single constellation satellite equipped with five sensors. However, the number of sensors on one constellation satellite is not limited to five.

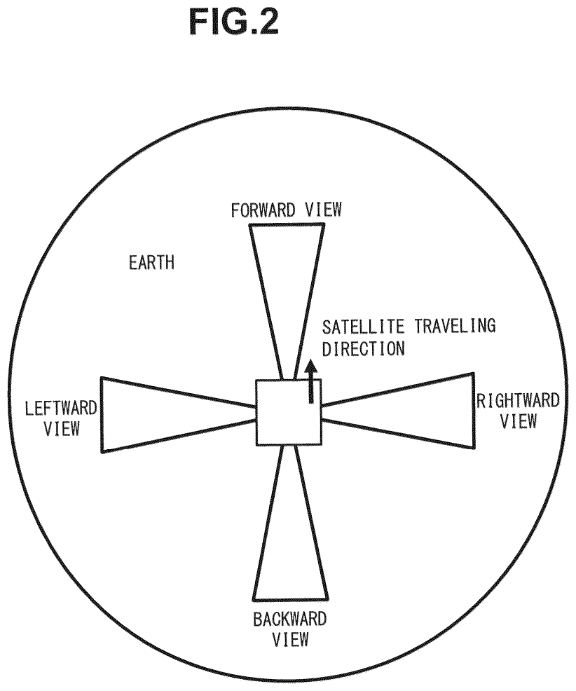

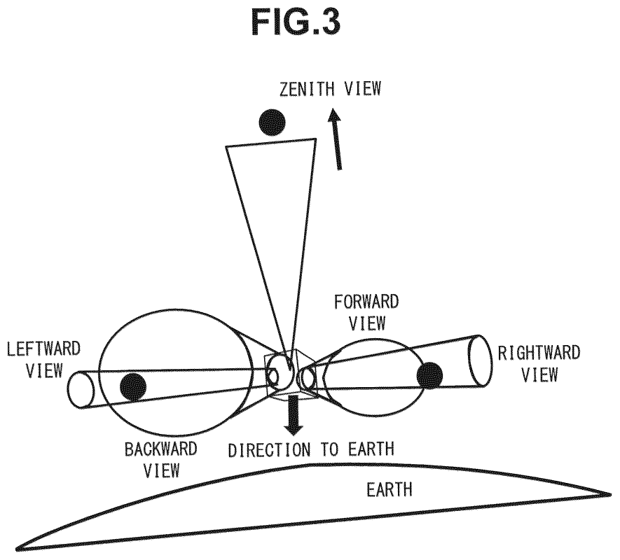

FIGS. 2 and 3 show a schematic diagram of the field of view of each sensor when a constellation satellite is equipped with five sensors. Five sensors enable observation of the forward view, backward view, rightward view, leftward view, and zenith view. The zenith view is not shown in FIG. 2.

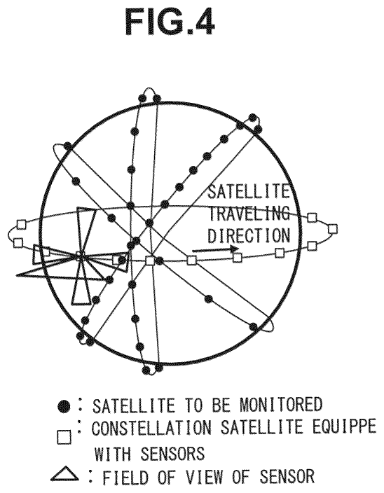

FIG. 4 is a schematic diagram showing the field of view of each sensor and its position relative to the earth and other satellites.

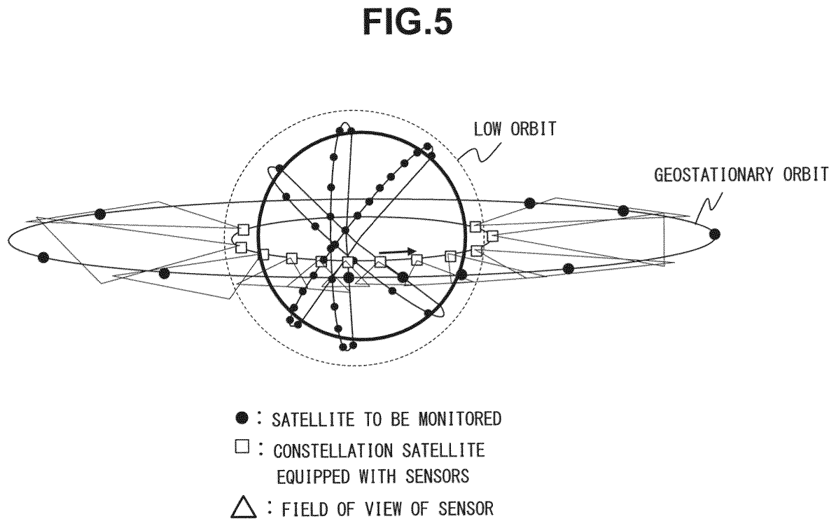

FIG. 5 is a schematic diagram showing examples of the zenith view in multiple constellation satellites.

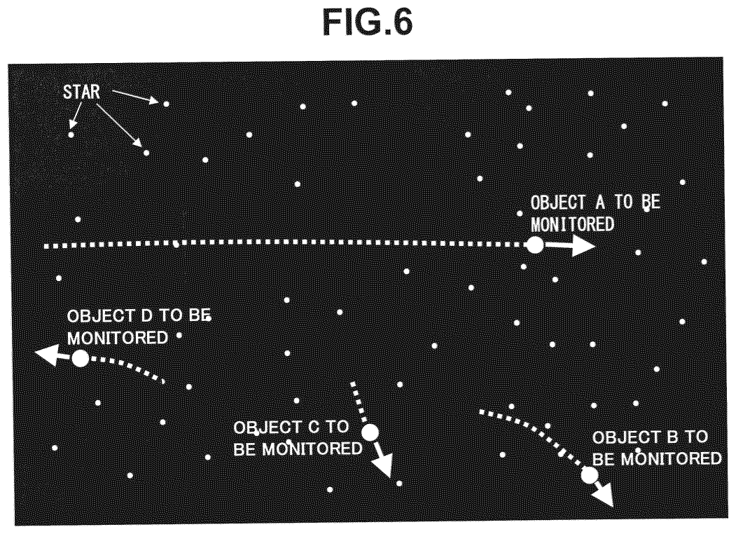

FIG. 6 is a schematic diagram showing an example of an image based on image data obtained by one sensor. One image contains many bright spots. As bright spots, there are bright spots of predetermined objects and bright spots of objects other than predetermined objects. The predetermined objects are objects whose position information is known. In this example, the predetermined objects are a star, a planet, and a space station. However, if there are satellites or rocket parts whose position information is known, such satellites or rocket parts may be included in the predetermined objects.

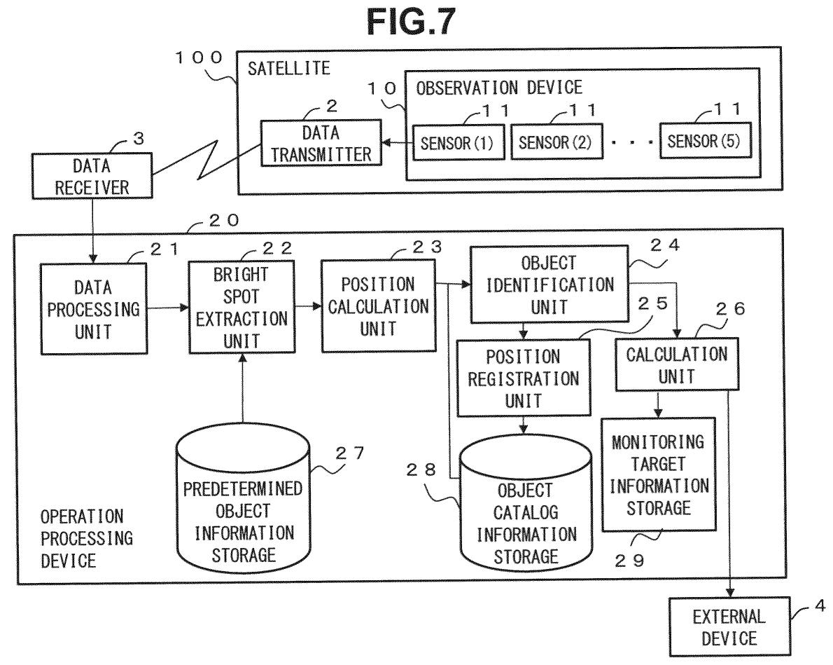

FIG. 7 is a block diagram showing an example of the configuration for the present disclosure. FIG. 7 also shows a satellite 100, a data receiver 3 and an external device 4 connected to the operation processing device 20.

The satellite 100 is a constellation satellite having multiple sensors. The satellite 100 comprises an observation device 10 and a data transmitter 2. In this example, the observation device 10 includes five sensors 11. Each sensor 11 generates image data by taking images. Each sensor 11 may take images constantly or periodically.

The data transmitter 2 transmits the image data generated by each of the 11 sensors to the data receiver 3.

The operation processing device 20, the data receiver 3 connected to the operation processing device 20, and the external device 4 are located on the ground.

The data receiver 3 is an antenna, for example. The data receiver 3 receives image data (image data generated by imaging at each sensor 11) transmitted from data transmitter 2.

In this example embodiment, the case in which the data receiver 3 and the operation processing device 20 are connected online and image data is transmitted from the data receiver 3 to the operation processing device 20 is used as an example. However, the data receiver 3 and the operation processing device 20 may not be connected, and the data receiver 3 may record the image data on a recording medium, and the operation processing device 20 may retrieve the image data from the recording medium.

In the present example, the case in which the operation processing device 20 and the external device 4 are connected online and data is transmitted from the operation processing device 20 (operation unit 26, described below) to the external device 4 is used as an example. However, the operation processing device 20 and the external device 4 may not be connected, and the operation processing device 20 may record the data on a recording medium, and the external device 4 may retrieve the data from the recording medium.

It should be noted that he external device 4 may not be provided.

The operation processing device 20 comprises a data processing unit 21, a bright spot extraction unit 22, a position calculation unit 23, an object identification unit 24, a position registration unit 25, a calculation unit 26, a predetermined object information storage 27, an object catalog information storage 28, and a monitoring target information storage 29.

The following explanation focuses on one sensor 11 and uses the case in which image data periodically obtained by the sensor 11 is transmitted from data receiver 3 to data processor 21. The same process is performed for other sensors 11.

The data processing unit 21 receives image data transmitted by the data receiver 3 to the operation processing device 20. This image data is the image data obtained by the sensor 11 installed in the satellite 100. The data processing unit 21 converts the image data received from the data receiver 3 into a format that can be recognized as an image. At this time, data processing unit 21 corrects pixel values of pixels in the image and corrects distortion of the image based on the inherent characteristics of the sensor 11 that generated the image data. If the image is distorted, the data processing unit 21 corrects the image distortion by changing the position of the pixels in the image.

The predetermined object information storage 27 is a storage device that stores position information of predetermined objects (in this example, stars, planets, and space stations) whose position information is known.

The bright point extraction unit 22 obtains position information of the predetermined object from the predetermined object information storage 27. Then, based on the position information of the predetermined object, the bright spot extraction unit 22 extracts bright spots other than the predetermined object from the bright spots in the image represented by the image data.

The bright spots other than the predetermined object extracted by the bright spot extraction unit 22 include bright spots of objects that do not correspond to the object to be monitored and bright spots of objects that do correspond to the object to be monitored. The objects that do not fall under the object to be monitored include satellites owned and operated by the organization of the home country. Examples of satellites owned and operated by national organizations include meteorological satellites and communication satellites. Since the purpose of these satellites is clear, and it is obvious that these satellites do not move in a way that would be detrimental to their own satellites, they do not fall under the category of objects to be monitored. Objects that fall under the category of objects to be monitored include newly detected objects, satellites of hostile countries or organizations of those countries, and satellites with offensive capabilities.

The position calculation unit 23 calculates the position of the object corresponding to the bright spot based on the position of the extracted bright spot in the image, and calculates the shooting time of image capture by the sensor 11. For example, the position calculation unit 23 calculates the shooting time of image capture by the sensor 11 by calculating backward from the time when the data receiver 3 receives the image data from the data transmitter 2. If the image data transmitted by the data transmitter 2 is associated with a shooting time, the position calculation unit 23 does not need to calculate the shooting time of image captured by the sensor 11, and only needs to identify the shooting time of image associated with the image data.

The object catalog information storage 28 is a storage device that stores object catalog information. The object catalog information is information about known objects.

The object catalog information includes, for example, the following information regarding known objects. However, the information included in the object catalog information is not limited to the following information.
(1) Object ID
(2) Object name
(3) Type
(4) Holding country
(5) Launch date
(6) Orbit information
(7) Operational organization

In this example embodiment, the object catalog information shall also include position information regarding known objects.

The orbit information is expressed in the form of TLE (Two Line Elements), for example.

The object identification unit 24 obtains a position information of a known object from the object catalog information stored in the object catalog information storage 28 and associates the object whose position is calculated with the known object based on the position information of the known object and the position calculated by the position calculation unit 23.

The position registration unit 25 registers the position and shooting time of image calculated by the position calculation unit 23 in the object catalog information, based on the result of the association by the object identification unit 24.

In addition, the position registration unit 25 registers positions and shooting times of objects that are not associated with known object as new object information in the object catalog information.

The position registration unit 25 overwrites the orbit information based on the position calculated by the position calculation unit 23.

Based on the result of the association, the object identification part 24 extracts the bright spot of the object to be monitored from the bright spots of other than the predetermined object. In other words, the object identification unit 24 extracts the bright spot of object associated with known object that corresponds to the object to be monitored.

Based on the result of the association by the object identification unit 24, the calculation unit 26 identifies the position and shooting time of the object to be monitored from the positions and the shooting times calculated by the position calculation unit 23.

The calculation unit 26 also calculates the direction and movement speed of the object to be monitored. Specifically, the calculation unit 26 calculates the direction and movement speed of the object to be monitored, based on the position and shooting time of the object to be monitored obtained based on the previous image data and the position and shooting time of the object to be monitored obtained based on the new image data. In FIG. 6, the movement directions of the object to be monitored A, B, C, and D calculated by the calculation unit 26 are shown schematically.

The monitoring target information storage 29 is a storage device that stores information regarding the object to be monitored. The calculation unit 26 stores the position of the object to be monitored, the shooting time, the movement direction, and to monitoring target information storage 29.

The calculation unit 26 transmits the position of the object to be monitored, the shooting time, the movement direction, and the movement speed to the external device 4.

The data processing unit 21, the bright spot extraction unit 22, the position calculation unit 23, the object identification unit 24, the position registration unit 25, and the calculation unit 26 are realized, for example, by a central processing unit (CPU) of a computer operating according to an operation processing program. In this case, the CPU may read the operation processing program from a program storage device or other program recording medium of the computer and operate as the data processing unit 21, the position calculation unit 23, the object identification unit 24, the position registration unit 25, and the calculation unit 26 according to the operation processing program.

The predetermined object information storage 27, the object catalog information storage 28, and the monitoring target information storage 29 are realized, for example, by the storage device in the computer described above.

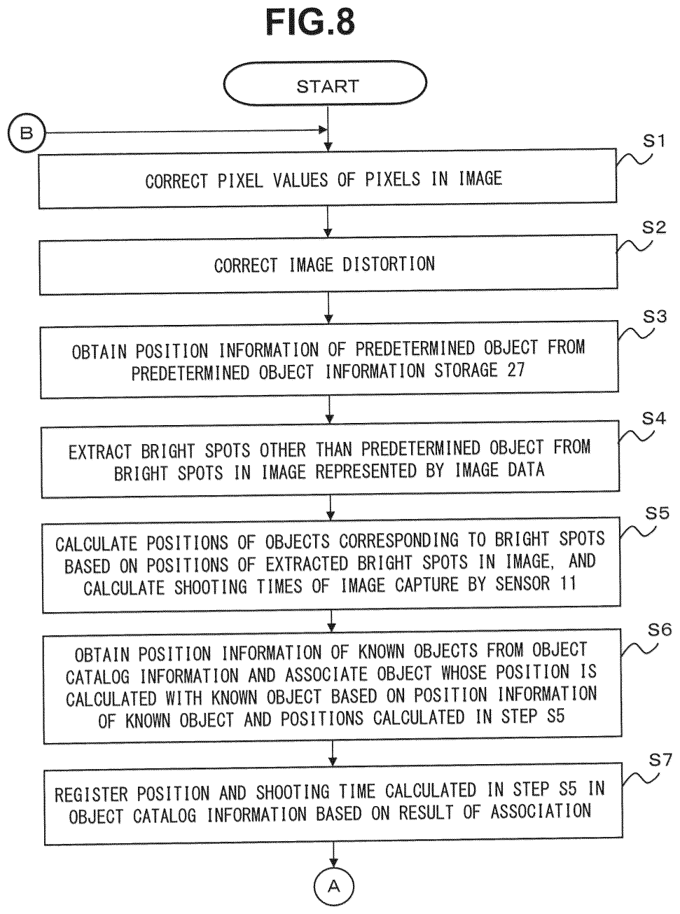

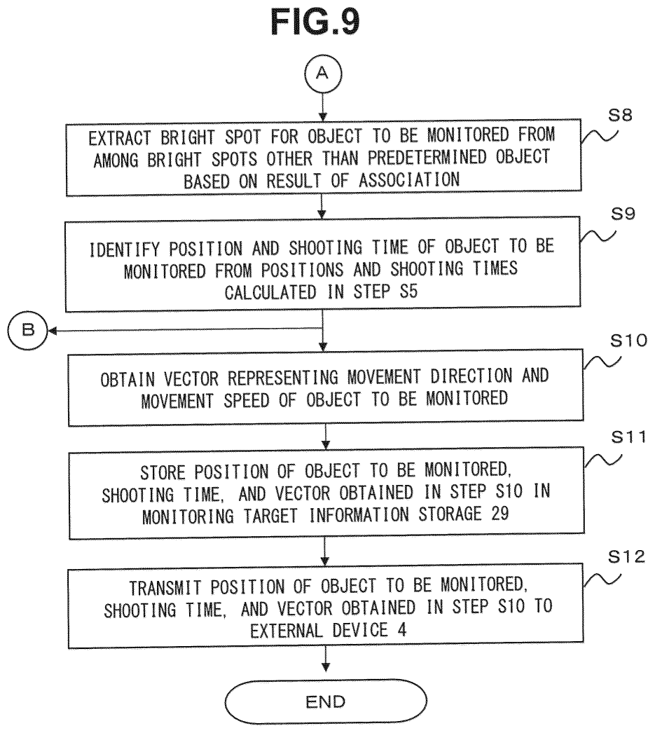

Next, the processing flow will be explained. FIGS. 8 and 9 are flowcharts showing an example of the processing flow of the operation processing unit 20. Detailed explanations of the items already described are omitted.

Assume that data processing unit 21 receives image data from data receiver 3. The data processing unit 21 converts the image data into a format that can be recognized as an image. At this time, the data processing unit 21 corrects pixel values of pixels in the image (step S1) and corrects image distortion (step S2).

Next, the bright point extraction unit 22 obtains the position information of the predetermined object from the predetermined object information storage 27 (step S3). Then, based on position information of a predetermined object, the bright spot extraction unit 22 extracts bright spots other than the predetermined object from bright spots in the image represented by the image data (step S4).

Next, the position calculation unit 23 calculates positions of the objects corresponding to the bright spots based on the positions of the extracted bright spots in the image, and calculates the shooting times of image capture by the sensor 11 (step S5).

Next, the object identifier 24 obtains the position information of known objects from the object catalog information and associates the object whose position is calculated with the known object based on the position information of the known object and the positions calculated in step S5 (step S6).

Next, the position registration unit 25 registers the position and shooting time calculated in step S5 in the object catalog information based on the result of association (step S7). The position registration unit 25 also registers the positions and shooting times of the objects that were not associated with the known objects as new object information in the object catalog information.

Next, the object identification unit 24 extracts a bright spot for an object to be monitored from among the bright spots other than the predetermined object based on the result of association (step S8).

Then, based on the result of association, the calculation unit 26 identifies the position and shooting time of the object to be monitored from the positions and the shooting times calculated in step S5 (step S9).

The process from step S1 to step S9 is repeated each time the data processing unit 21 receives new image data.

After step S9, the calculation unit 26 obtains a vector representing the movement direction and movement speed of the object to be monitored (step S10). The calculation unit 26 can obtain a vector representing the moving direction and moving speed of the object to be monitored based on the position and shooting time of the object to be monitored obtained based on the previous image data and the position and shooting time of the object to be monitored obtained based on the new image data. Obtaining the vector means to obtain the movement direction and movement speed of the object to be monitored.

Then, the calculation unit 26 stores the position of the object to be monitored, the shooting time, and the vector obtained in step S10 in the monitoring target information storage 29 (step S11).

The calculation unit 26 transmits the position of the object to be monitored, the shooting time, and the vector obtained in step S10 to the external device 4 (step S12).

According to this example embodiment, the position of objects in space can be observed constantly or periodically without various restrictions or regulations. In this example embodiment, a constellation satellite is equipped with multiple sensors such as optical cameras to enable constant or periodic observation of space.

The installation of multiple sensors on multiple constellation satellites will allow more information to be obtained, and the increased amount of information obtained will allow the position of the object to be monitored to be determined more precisely.

Furthermore, since this system obtains not only the position of the object to be monitored but also a vector representing the movement direction and movement speed of the object to be monitored, it can predict with high accuracy where the object to be monitored is going to move to or what action it is planning to take.

In FIG. 1 and other figures, the case in which the constellation satellite equipped with the sensor is in low orbit is shown as an example, but the constellation satellite equipped with the sensor may be in geostationary orbit.

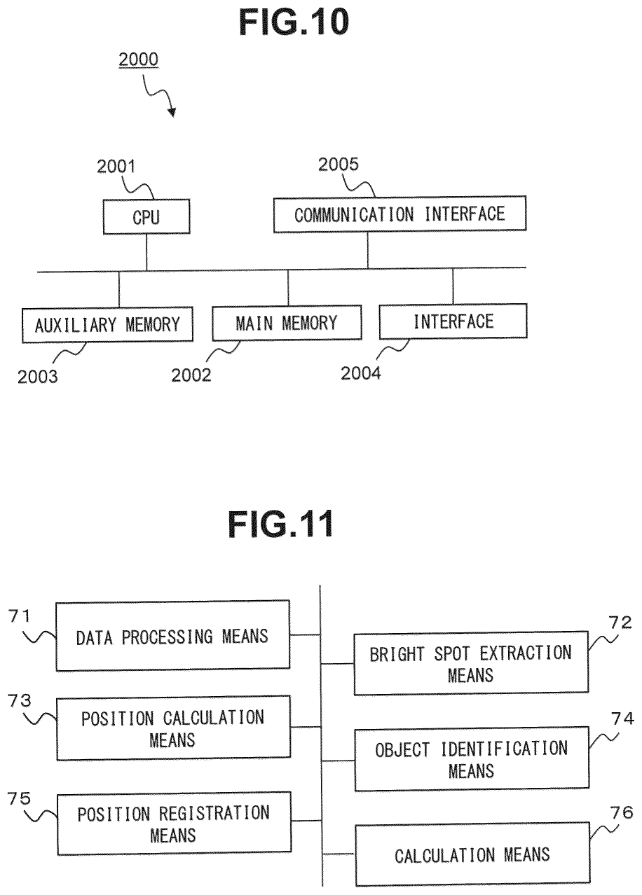

FIG. 10 is a block diagram showing an example of the configuration of a computer for the operation processing device. The computer 2000 comprises a CPU 2001, a main memory 2002, an auxiliary memory 2003, an interface 2004, and a communication interface 2005, for example. The communication interface 2005 is an interface to the data receiver 3 and the external device 4.

The operation processing device of present disclosure is realized by the computer 2000, for example. The operation of the operation processing device is stored in the auxiliary memory 2003 in a form of a program (operation processing program), and the CPU 2001 reads the program from the auxiliary memory 2003, expands the program in main memory 2002, and executes the processing described in the above example embodiment according to the program. The CPU 2001 loads the program from auxiliary memory 2003 into main memory 2002, and, according to the program, performs the processing described in the above example embodiment.

The auxiliary storage apparatus 2003 is an example of a non-temporary tangible medium. Other examples of non-transitory tangible media include a magnetic disk, an magneto-optical disk, a CD-ROM (Compact Disk Read Only Memory), DVD-ROM (Digital Versatile Disk Read Only Memory), DVD-ROM (Digital Disk Read Only Memory), a semiconductor memory, etc., connected through interface 2004.

Next, an overview of the operation processing device for present disclosure will be explained. FIG. 11 is a block diagram showing an overview of the operation processing device for the present disclosure. The operation processing unit comprises data processing means 71, bright spot extraction means 72, position calculation means 73, object identification means 74, position registration means 75, and arithmetic means 76.

Data processing means 71 (for example, data processing unit 21) converts image data obtained by sensors installed on an observation satellite into a format that can be recognized as an image.

The bright point extraction means 72 (for example, the bright point extraction unit 22) extracts bright spots other than predetermined objects from bright spots in the image represented by the image data.

The position calculation means 73 (for example, the position calculation unit 23) calculates positions of objects corresponding to the bright spots based on positions of the extracted bright spots in the image, and calculating shooting times of image captured by the sensors.

The object identification means 74 (for example, the object identification unit 24) obtains position information of known objects from object catalog information, and associating the objects whose positions are calculated with a known object, based on the position information of the known object and the calculated positions.

The position registration means 75 (for example, the position registration unit 25) registers the calculated position and shooting time of image in the object catalog information, based on a result of association.

The object identification means 74 extracts the bright spot to be monitored from the bright spots other than the predetermined objects, based on the result of association.

The calculation means 76 (for example, the calculation unit 26) identifies the position and shooting time of an object to be monitored. Then, the calculation means 76 calculates a movement direction and movement speed of the object to be monitored.

Such a configuration allows for constant or periodic observation of the position of an object in space without various restrictions or regulations.

A part of or all of the above example embodiments may also be described as, but not limited to, the following supplementary notes.

### Supplementary Note 1

An operation processing device comprising:
data processing means for converting image data obtained by sensors installed on an observation satellite into a format that can be recognized as an image,
bright spot extraction means for extracting bright spots other than predetermined objects from bright spots in the image represented by the image data,
position calculation means for calculating positions of objects corresponding to the bright spots based on positions of the extracted bright spots in the image, and calculating shooting times of image captured by the sensors,
object identification means for obtaining position information of known objects from object catalog information, and associating the objects whose positions are calculated with a known object, based on the position information of the known object and the calculated positions,
position registration means for registering the calculated position and shooting time of image in the object catalog information, based on a result of association, and
calculation means for identifying the position and shooting time of an object to be monitored,
wherein
the object identification means extracts the bright spot to be monitored from the bright spots other than the predetermined objects, based on the result of association, and
the calculation means calculates a movement direction and movement speed of the object to be monitored.

### Supplementary Note 2

The operation processing device according to Supplementary note 1, wherein
the calculation means calculates the movement direction and movement speed of the object to be monitored, based on the position and shooting time of the object to be monitored obtained based on previous image data and the position and shooting time of the object to be monitored obtained based on the new image data.

### Supplementary Note 3

The operation processing device according to Supplementary note 1 or 2, wherein
the position registration means registers the positions and shooting times of objects that are not associated with the known objects as new object information in the object catalog information.

### Supplementary Note 4

An operation processing method comprising:
converting image data obtained by sensors installed on an observation satellite into a format that can be recognized as an image,
extracting bright spots other than predetermined objects from bright spots in the image represented by the image data,
calculating positions of objects corresponding to the bright spots based on positions of the extracted bright spots in the image, and calculating shooting times of image captured by the sensors,
obtaining position information of known objects from object catalog information, and associating the objects whose positions are calculated with a known object, based on the position information of the known object and the calculated positions,
registering the calculated position and shooting time of image in the object catalog information, based on a result of association,
extracting the bright spot to be monitored from the bright spots other than the predetermined objects, based on the result of association,
identifying the position and shooting time of an object to be monitored, and
calculating a movement direction and movement speed of the object to be monitored.

### Supplementary Note 5

An operation processing program causing a computer to execute
a process of converting image data obtained by sensors installed on an observation satellite into a format that can be recognized as an image,
a process of extracting bright spots other than predetermined objects from bright spots in the image represented by the image data,
a process of calculating positions of objects corresponding to the bright spots based on positions of the extracted bright spots in the image, and calculating shooting times of image captured by the sensors,
a process of obtaining position information of known objects from object catalog information, and associating the objects whose positions are calculated with a known object, based on the position information of the known object and the calculated positions,
a process of registering the calculated position and shooting time of image in the object catalog information, based on a result of association,
a process of extracting the bright spot to be monitored from the bright spots other than the predetermined objects, based on the result of association,
a process of identifying the position and shooting time of an object to be monitored, and
a process of calculating a movement direction and movement speed of the object to be monitored.

Some or all of the configurations described in Supplementary notes 2 or 3, which are dependent on Supplementary note 1 described above, can be dependent on Supplementary notes 4 and 5 by the same dependency relationship as Supplementary notes 2 or 3. Furthermore, not limited to Supplementary note 1, Supplementary note 4, and Supplementary note 5, some or all of the configurations described as Supplementary notes can be similarly subordinated to various hardware, software, various recording means for recording software, or systems, to the extent not deviating from the example embodiments described above.

Although the present disclosure has been described above with reference to example embodiments, the present disclosure is not limited to the above example embodiments. Various changes can be made to the configuration and details of the present disclosure that can be understood by those skilled in the art within the scope of the present disclosure.

What is claimed is:

1. An operation processing device comprising:
data processing unit which converts image data obtained by sensors installed on an observation satellite into a format that can be recognized as an image,
bright spot extraction unit which extracts bright spots other than predetermined objects from bright spots in the image represented by the image data,
position calculation unit which calculates positions of objects corresponding to the bright spots based on positions of the extracted bright spots in the image, and calculates shooting times of image captured by the sensors,
object identification unit which obtains position information of known objects from object catalog information, and associates the objects whose positions are calculated with a known object, based on the position information of the known object and the calculated positions,
position registration unit which registers the calculated position and shooting time of image in the object catalog information, based on a result of association, and
calculation unit which identifies the position and shooting time of an object to be monitored,
wherein
the object identification unit extracts the bright spot to be monitored from the bright spots other than the predetermined objects, based on the result of association, and
the calculation unit calculates a movement direction and movement speed of the object to be monitored.

2. The operation processing device according to claim 1, wherein
the calculation unit calculates the movement direction and movement speed of the object to be monitored, based on the position and shooting time of the object to be monitored obtained based on previous image data and the position and shooting time of the object to be monitored obtained based on the new image data.

3. The operation processing device according to claim 1, wherein
the position registration unit registers the positions and shooting times of objects that are not associated with the known objects as new object information in the object catalog information.

4. The operation processing device according to claim 2, wherein
the position registration unit registers the positions and shooting times of objects that are not associated with the known objects as new object information in the object catalog information.

5. An operation processing method comprising:
converting image data obtained by sensors installed on an observation satellite into a format that can be recognized as an image,
extracting bright spots other than predetermined objects from bright spots in the image represented by the image data,
calculating positions of objects corresponding to the bright spots based on positions of the extracted bright spots in the image, and calculating shooting times of image captured by the sensors,
obtaining position information of known objects from object catalog information, and associating the objects whose positions are calculated with a known object, based on the position information of the known object and the calculated positions,
registering the calculated position and shooting time of image in the object catalog information, based on a result of association,
extracting the bright spot to be monitored from the bright spots other than the predetermined objects, based on the result of association,
identifying the position and shooting time of an object to be monitored, and
calculating a movement direction and movement speed of the object to be monitored.

6. The operation processing method according to claim 5, wherein
the movement direction and movement speed of the object to be monitored is calculated, based on the position and shooting time of the object to be monitored obtained based on previous image data and the position and shooting time of the object to be monitored obtained based on the new image data.

7. The operation processing method according to claim 5, wherein
the positions and shooting times of objects that are not associated with the known objects are registered as new object information in the object catalog information.

8. The operation processing method according to claim 6, wherein
the positions and shooting times of objects that are not associated with the known objects are registered as new object information in the object catalog information.

9. A non-transitory computer readable recording medium storing an operation processing program which, when executed by a processor, performs:
converting image data obtained by sensors installed on an observation satellite into a format that can be recognized as an image,
extracting bright spots other than predetermined objects from bright spots in the image represented by the image data,
calculating positions of objects corresponding to the bright spots based on positions of the extracted bright spots in the image, and calculating shooting times of image captured by the sensors,
obtaining position information of known objects from object catalog information, and associating the objects whose positions are calculated with a known object, based on the position information of the known object and the calculated positions,
registering the calculated position and shooting time of image in the object catalog information, based on a result of association,
extracting the bright spot to be monitored from the bright spots other than the predetermined objects, based on the result of association,
identifying the position and shooting time of an object to be monitored, and
calculating a movement direction and movement speed of the object to be monitored.
